(19) United States
(12) Patent Application Publication
(10) Pub. No.: US 2025/0119863 A1
(43) Pub. Date: Apr. 10, 2025

(54) METHOD FOR LOCATION SERVICE IN EDGE COMPUTING

(71) Applicant: ZTE CORPORATION, Shenzhen (CN)

(72) Inventors: Jinguo ZHU, Shenzhen (CN); Zhijun LI, Shenzhen (CN); Wanpeng FAN, Shenzhen (CN)

(21) Appl. No.: 18/681,323

(22) PCT Filed: Aug. 13, 2021
(86) PCT No.: PCT/CN2021/112595

§ 371 Date: Feb. 5, 2024

(51) Int. Cl. H04W 64/00; H04L 12/14

(52) U.S. Cl. CPC H04W 64/00; H04L 12/1407

(57) ABSTRACT

A wireless communication method for use in a location management function is disclosed. The method comprises transmitting, to a policy control function, a rule creating message associated with a location service for the location management function, transmitting, to a user plane function, a downlink network positioning message associated with the location service of a wireless terminal, and receiving, from the user plane function, an uplink network positioning message comprising location information of the wireless terminal.

This document is directed generally to wireless communications, and in particular to a location service in edge computing.

In a location service (LCS) procedure, a location of a user equipment (UE) is calculated in a location management function (LMF) which is deployed in the public network. In some deployments, e.g., at private enterprise, UE location data is sensitive data and a data owner may not want to expose the UE location data to the public network. Thus, a solution of supporting the LCS without exposing the UE location data to the public network may be needed.

This document relates to methods, systems, and devices for the LCS in edge computing, and in particular to methods, systems, and devices in user plane for the LCS in edge computing.

The present disclosure relates to a wireless communication method for use in a location management function. The method comprises:
transmitting, to a policy control function, a rule creating message associated with a location service for the location management function,
transmitting, to a user plane function, a downlink network positioning message associated with the location service of a wireless terminal, and
receiving, from the user plane function, an uplink network positioning message comprising location information of the wireless terminal.

Various embodiments may preferably implement the following features:

Preferably, the rule creating message comprises at least one of a data network access identifier associated with the location management function, a traffic description associated with a network positioning message of the location service, a routing identifier associated with the location management function or a location service correlation identifier associated with the location management function.

Preferably, the downlink network positioning message comprises an internet protocol address associated with the wireless terminal.

Preferably, the uplink network positioning message further comprises at least one of a routing identifier associated with the location management function or a location service correlation identifier associated with the location management function.

The present disclosure relates to a wireless communication method for use in a policy control function. The method comprises:
receiving a rule creating message associated with a location service for a location management function, and transmitting, to a session management function, a policy control and charging rule of a protocol data unit session associated with the location service.

Various embodiments may preferably implement the following features:

Preferably, the rule creating message is received from the location management function or a user data repository.

Preferably, the rule creating message comprises at least one of a data network access identifier associated with the location management function, a traffic description associated with a network positioning message of the location service, a routing identifier associated with the location management function or a location service correlation identifier associated with the location management function.

Preferably, the policy control and charging rule comprises at least one of a data network access identifier associated with the location management function, a traffic description associated with a network positioning message of the location service, a routing identifier associated with the location management function or a location service correlation identifier associated with the location management function.

Preferably, the wireless communication method further comprises determining the protocol data unit session based on the rule creating message.

Preferably, the wireless communication method further comprises generating the policy control and charging rule based on the rule creating message.

The present disclosure relates to a wireless communication method for use in a session management function. The method comprises:
receiving, from a policy control function, a policy control and charging rule associated with a protocol data unit session allocated for a location service of a location management function, and
transmitting, to a user plane function, information of a quality of service flow allocated for the location service.

Various embodiments may preferably implement the following features:

Preferably, the policy control and charging rule comprises at least one of a data network access identifier associated with the location management function, a traffic description associated with a network positioning message of the location service, a routing identifier associated with the location management function or a location service correlation identifier associated with the location management function.

Preferably, the information of the quality of service flow comprises at least one of a traffic description associated with a network positioning message of the location service, a routing identifier associated with the location management function or a location service correlation identifier associated with the location management function.

Preferably, the wireless communication method further comprises determining the user plane function according to a data network access identifier comprised in the policy control and charging rule.

Preferably, the wireless communication method further comprises transmitting, to at least one of the user plane function or a wireless network node, an indication of setting a flag configured to indicate a network positioning message of the location service.

Preferably, the wireless communication method further comprises transmitting, to the wireless network node, the flag configured to identify the network positioning message of the location service.

Preferably, the flag is used in a general packet radio service tunneling protocol user plane header.

The present disclosure relates to wireless communication method for use in a user plane function. The method comprises:
receiving, from a session management function, information of a quality of service flow allocated for a location service of a location management function,
receiving, from the location management function, a downlink network positioning message associated with the location service of a wireless terminal based on the information,
transmitting, to a wireless network node, the downlink network positioning message,
receiving, from the wireless network node, an uplink network positioning message comprising location information of the wireless terminal based on the information, and
transmitting, to the location management function, the uplink network positioning message.

Various embodiments may preferably implement the following features:

Preferably, the information of the quality of service flow allocated for the location service comprises at least one of a traffic description associated with a network positioning message of the location service, a routing identifier associated with the location management function or a location service correlation identifier associated with the location management function.

Preferably, the downlink network positioning message is transmitted and the uplink network positioning message is received in a general packet radio service tunneling protocol user plane message.

Preferably, a header of the general packet radio service tunneling protocol user plane comprises at least one of an identifier of the quality of service flow allocated for the location service or a flag configured to identify the network positioning message of the location service.

Preferably, the wireless communication method further comprises receiving, from a session management function, an indication of setting the flag.

Preferably, the uplink network positioning message further comprises at least one of a routing identifier associated with the location management function or a location service correlation identifier associated with the location management function.

The present disclosure relates to a wireless communication method for use in a wireless network node, the method comprising:
receiving, from a session management function, information of a quality of service flow allocated for a location service of a location management function,
receiving, from a user plane function, a downlink network positioning message associated with the location service of a wireless terminal based on the information, and
transmitting, to the user plane function, an uplink network positioning message comprising location information of the wireless terminal.

Various embodiments may preferably implement the following features:

Preferably, the downlink network positioning message is transmitted and the uplink network positioning message is received in a general packet radio service tunneling protocol user plane message.

Preferably, the downlink network positioning message and the uplink network positioning message comprise an identifier of the quality of service flow.

Preferably, the downlink network positioning message and the uplink network positioning message comprise a flag configured to indicate the network positioning message of the location service.

Preferably, the wireless communication method further comprises receiving, from the session management function, an indication of setting the flag.

Preferably, the flag is used in a general packet radio service tunneling protocol user plane header.

The present disclosure relates to a wireless device comprising a location management function. The wireless device comprises a communication unit, configured to:
transmit, to a policy control function, a rule creating message associated with a location service for the location management function,
transmit, to a user plane function, a downlink network positioning message associated with the location service of a wireless terminal, and
receive, from the user plane function, an uplink network positioning message comprising location information of the wireless terminal.

Various embodiments may preferably implement the following feature:

Preferably, the wireless device further comprises a processor configured to perform any of aforementioned wireless communication methods.

The present disclosure relates to a wireless device comprising a policy control function. The wireless device comprises a communication unit, configured to:
receive a rule creating message associated with a location service for a location management function, and
transmit, to a session management function, a policy control and charging rule of a protocol data unit session associated with the location service.

Various embodiments may preferably implement the following feature:

Preferably, the wireless device further comprises a processor configured to perform any of aforementioned wireless communication methods.

The present disclosure relates to a wireless device comprising a session management function. The wireless device comprises a communication unit, configured to:
receive, from a policy control function, a policy control and charging rule associated with a protocol data unit session allocated for a location service of a location management function, and
transmit, to a user plane function, information of a quality of service flow allocated for the location service.

Various embodiments may preferably implement the following feature:

Preferably, the wireless device further comprises a processor configured to perform any of aforementioned wireless communication methods.

The present disclosure relates to a wireless device comprising a user plane function. The wireless device comprises a communication unit, configured to:
receive, from a session management function, information of a quality of service flow allocated for a location service of a location management function,
receive, from the location management function, a downlink network positioning message associated with the location service of a wireless terminal based on the information,
transmit, to a wireless network node, the downlink network positioning message,
receive, from the wireless network node, an uplink network positioning message comprising location information of the wireless terminal based on the information, and
transmit, to the location management function, the uplink network positioning message.

Various embodiments may preferably implement the following feature:

Preferably, the wireless device further comprises a processor configured to perform any of aforementioned wireless communication methods.

The present disclosure relates to a wireless network node. The wireless network node comprises a communication unit configured to:
receive, from a session management function, information of a quality of service flow allocated for a location service of a location management function,
receive, from a user plane function, a downlink network positioning message associated with the location service of a wireless terminal based on the information, and
transmit, to the user plane function, an uplink network positioning message comprising location information of the wireless terminal.

Various embodiments may preferably implement the following feature:

Preferably, the wireless network node further comprises a processor configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

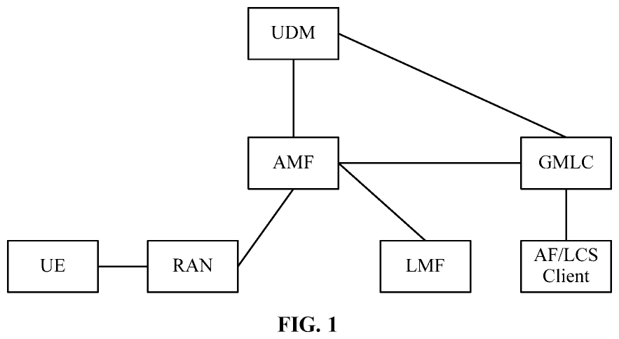

FIG. 1 shows a schematic diagram of a location service architecture according to an embodiment of the present disclosure.

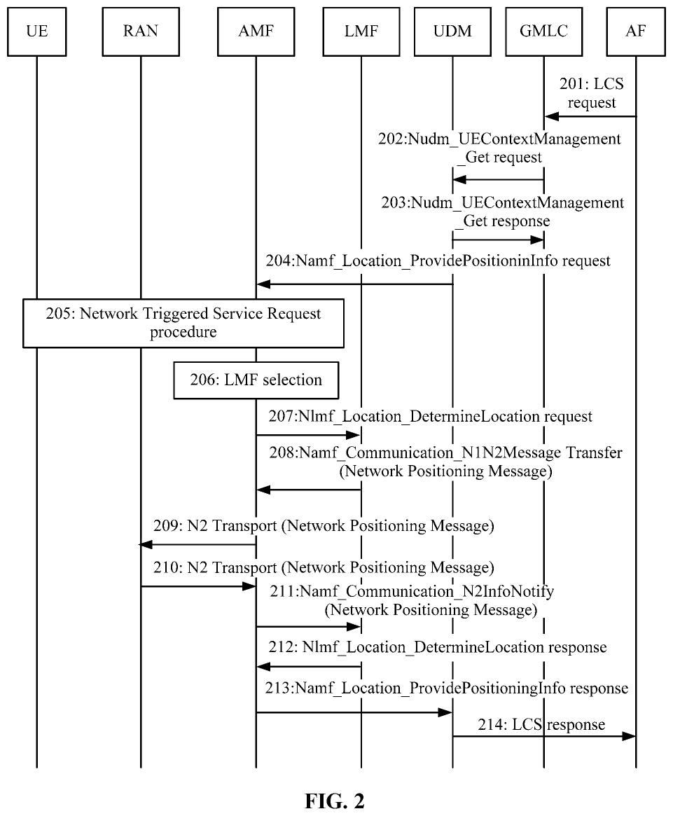

FIG. 2 shows a schematic diagram of a mobile terminated location request service procedure according to an embodiment of the present disclosure.

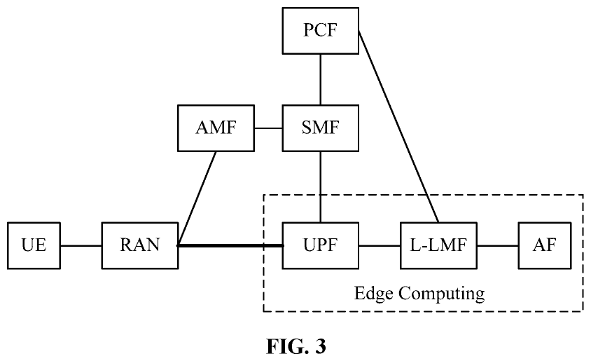

FIG. 3 shows a schematic diagram of a location service architecture according to an embodiment of the present disclosure.

FIG. 4 show a schematic diagram of a mobile terminated location request procedure according to an embodiment of the present disclosure.

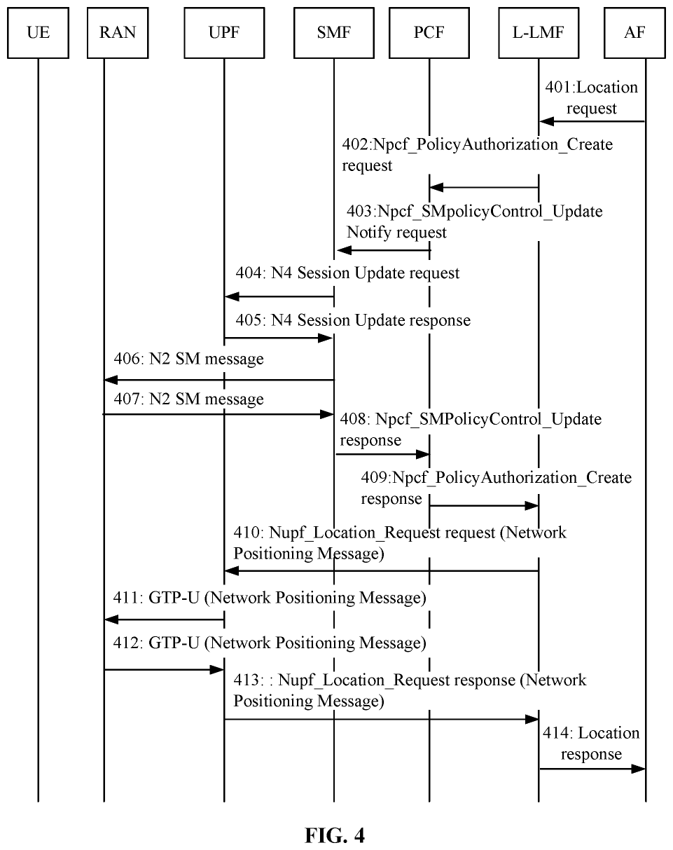

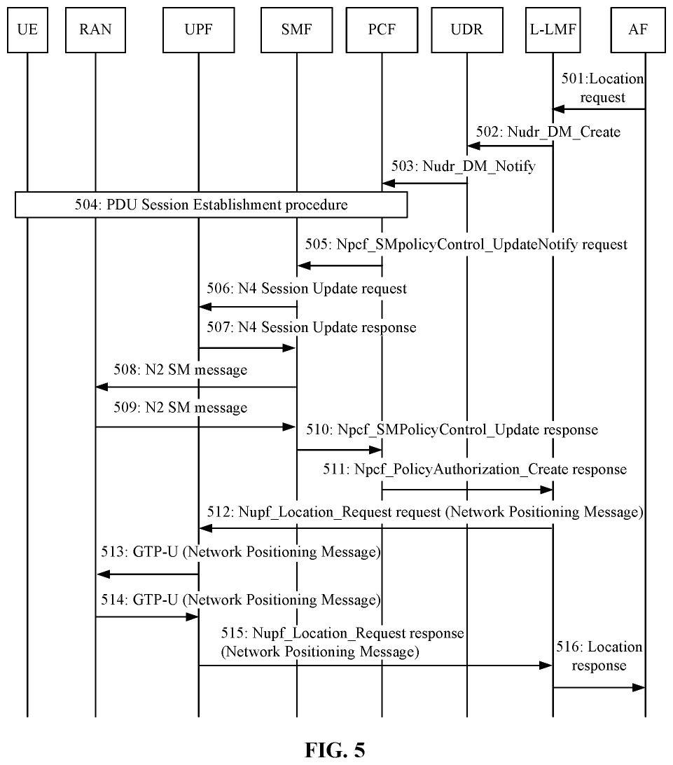

FIG. 5 show a schematic diagram of a mobile terminated location request procedure according to an embodiment of the present disclosure.

FIG. 6 shows an example of a schematic diagram of a wireless terminal according to an embodiment of the present disclosure.

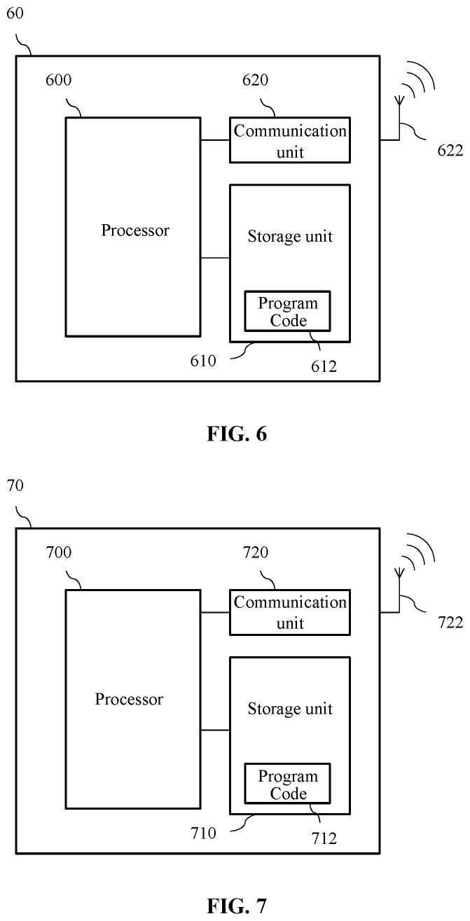

FIG. 7 shows an example of a schematic diagram of a wireless network node according to an embodiment of the present disclosure.

FIG. 8 shows a flowchart of a method according to an embodiment of the present disclosure.

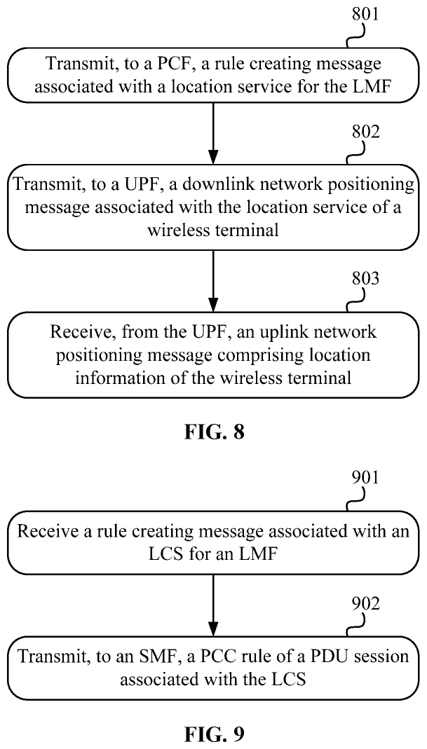

FIG. 9 shows a flowchart of a method according to an embodiment of the present disclosure.

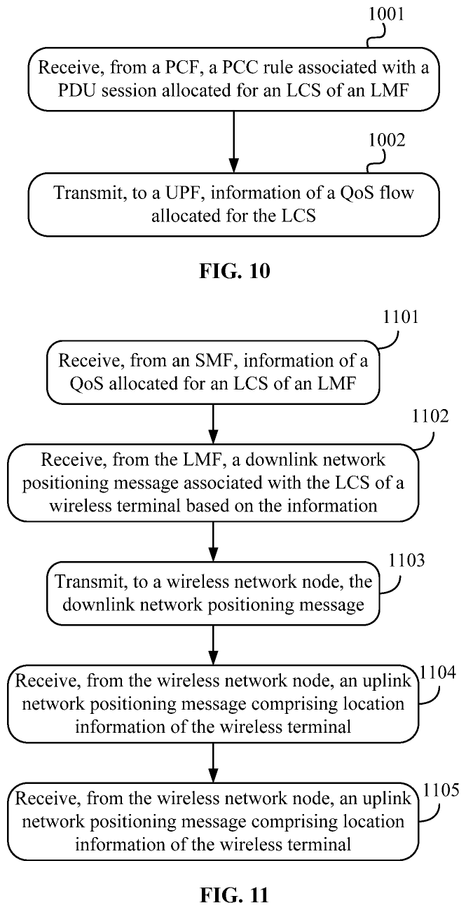

FIG. 10 shows a flowchart of a method according to an embodiment of the present disclosure.

FIG. 11 shows a flowchart of a method according to an embodiment of the present disclosure.

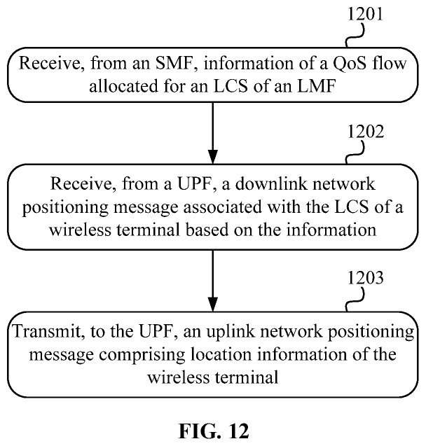

FIG. 12 shows a flowchart of a method according to an embodiment of the present disclosure.

FIG. 1 shows a schematic diagram of a location service (LCS) architecture according to an embodiment of the present disclosure. The LCS architecture comprises the following network functions and entities:
1) UE (user equipment): The UE can provide UE assistant information to LMF so the LMF can calculate the UE location.
2) RAN (radio access network): The RAN is involved in the handling of various positioning procedures including positioning of a target UE, provision of location related information not associated with a particular target UE and transfer of positioning messages between the target UE and an access and mobility management function (AMF) or a location management function (LMF). The RAN supports determination of location estimations in geographical and/or local co-ordinates. In this embodiment, the RAN may refer to RAN node.
3) AMF (access and mobility management function): The AMF includes the following functionalities: registration management, connection management, reachability management and mobility management. The AMF also performs the access authentication and access authorization. The AMF is a non-access stratum (NAS) security termination. The AMF can relay the NAS between UE and LMF, etc. The AMF also selects a proper LMF when receiving a location request from the GMLC.
4) UDM (user data management): This function provides UE subscription information to the GMLC. The UDM also maintains the serving AMF information that the UE is currently registered. Thus, when the UE subscription is updated, the UDM is able to provide the updated UE subscription to the AMF. The UDM contains LCS subscriber LCS privacy profile. In the present disclosure, the UDM may be collocated with a UDR (user data repository).
5) LMF (location management function): The LMF calculates and/or verifies the UE location and any velocity estimation and may estimate the achieved accuracy. The LMF receives location requests for a target UE from the serving AMF. The LMF interacts with the UE to exchange location information applicable to UE assisted and UE based position methods and interacts with the RAN in order to obtain the location information of the target UE.
6) GMLC (gateway mobile location centre): The GMLC contains functionalities required to support LCS. The GMLC is the first node accessed by an external LCS client (i.e. application function (AF)) in a public land mobile network (PLMN). The AFs and network functions (NFs) may access the GMLC directly or via a network exposure function (NEF). The GMLC may request routing information and/or target UE privacy information from the UDM. After performing authorization of an external LCS client or AF and verifying target UE privacy information, the GMLC forwards a location request to a serving AMF.
7) AF/LCS client: The AFs/LCS clients and NFs may access LCS services from the GMLC.

FIG. 2 shows a schematic diagram of a mobile terminated location request service procedure according to an embodiment of the present disclosure. The mobile terminated location request service procedure shown in FIG. 2 comprises the following steps:

Step 201: The external LCS client (i.e. AF) sends a LCS request to the GMLC for a location (information) of a target UE. In an embodiment, the target UE is identified by a GPSI (Generic Public Subscription Identifier) or an SUPI (subscription permanent identifier).

Step 202: The GMLC invokes a Nudm_UECM_Get service operation towards the home UDM of the target UE being located with the GPSI or the SUPI.

Step 203: The UDM returns a network addresses of the current serving AMF of the target UE.

Step 204: The GMLC invokes a Namf_Location_ProvidePositioningInfo service operation towards the AMF to request the current location of the UE. The service operation includes the SUPI, and client type and may include the required QoS and Supported GAD shapes.

Step 205: If the UE is in a connection management idle (CM IDLE) state, the AMF initiates a network triggered Service Request procedure to establish a signaling connection with the UE.

Step 206: The AMF selects an LMF based on the available information or based on AMF local configuration. The LMF selection may take the RAN currently serving the UE into account. The AMF may also query an NRF (Network Repository Function) to select the LMF.

Step 207: The AMF invokes a Nlmf_Location_DetermineLocation service operation towards the LMF to request the current location of the UE. The service operation includes an LCS Correlation identifier, the serving cell identity of the RAN, and the client type, the required QOS, UE Positioning Capability, if available, and Supported GAD shapes. The service operation may also include the AMF identity.

Step 208: The LMF invokes the Namf_Communication_NIN2MessageTransfer service operation towards the AMF to request the transfer of a Network Positioning message to the serving RAN node for the UE. The service operation includes the Network Positioning message and the LCS Correlation identifier. The Network Positioning message may request the location information for the target UE from the RAN.

Step 209: The AMF forwards the Network Positioning message to the serving RAN node in an N2 Transport message. The AMF includes a Routing identifier identifying the LMF (e.g. a global address of the LMF) in the N2 Transport message.

Step 210: The RAN node obtains any location information for the UE requested. The serving RAN node returns any location information to the AMF in a Network Positioning message included in an N2 Transport message. The serving RAN node shall also include the Routing identifier in the N2 Transport message received in step 209.

Step 211: The AMF invokes the Namf_Communication_N2InfoNotify service towards the LMF indicated by the routing identifier. The service operation includes the Network Positioning message and the LCS Correlation identifier. Steps 208 to 211 may be repeated to request further location information and further RAN capabilities.

Step 212: The LMF returns the Nlmf_Location_DetermineLocation Response towards the AMF to return the current location of the UE. The service operation includes the LCS Correlation identifier, the location estimate, its age and accuracy and may include information about the positioning method.

Step 213: The AMF returns the Namf_Location_ProvidePositioningInfo Response towards the GMLC to return the current location of the UE. The service operation includes the location estimate, its age and accuracy and may include information about the positioning method.

Step 214: The GMLC sends the LCS response to the external location services client.

In FIG. 2, the UE location is calculated in the LMF which is deployed in the core network. In some embodiments, a network provider (e.g. an enterprise) may not want to expose the UE location information to outside of a local area of the provided network.

FIG. 3 shows a schematic diagram of a location service architecture according to an embodiment of the present disclosure. In FIG. 3, the LMF is deployed in a local area/edge computing area. In this embodiment, the LMF deployed in the local area/edge computing area is called local LMF (L-LMF). The L-LMF calculates the UE location and exposes the UE location to a local AF/LCS client. Note that the network function(s) in the core network is not involved during the location calculation procedure in this embodiment.

In FIG. 3, the RAN may connect to the L-LMF via the UPF. The interface between the RAN and the UPF is based on a general packet radio service (GPRS) tunneling protocol user plane (GTP-U) protocol. The network may use a dedicated quality of service (QOS) flow or an existing QoS flow for network positioning message(s) (e.g. downlink network positioning message or uplink network positioning message) between the RAN and UPF. In both cases, a GTP-U header associated with the network positioning message may include a flag indicating that the content of the GTP-U packet is the network positioning message. The RAN and UPF therefore can handle (e.g. determine) the network positioning message(s) based on the flag.

In an embodiment, an interface between the UPF and the L-LMF could be a service-based interface or an implementation specific interface, e.g. an internet protocol (IP) tunnel.

In an embodiment, the L-LMF may not connect to the AMF because the network operator may want to isolate the local network from the public network. Therefore, the L-LMF is not selected by the AMF but by the AF/LCS client based on the local configuration. The L-LMF acts as the AF when it interacts with the core network (e.g. 5G core (5GC) network).

FIG. 4 show a schematic diagram of a mobile terminated location request procedure according to an embodiment of the present disclosure. In FIG. 4, the local LCS client (i.e. AF) requests the UE location information from the L-LMF and the L-LMF requests the UE location information from the RAN node serving the UE. More specifically, the mobile terminated location request procedure comprises the following steps:

Step 401: The external LCS client (i.e. AF) sends a location request to the L-LMF for the location information (e.g. a location) of a target UE identified by an IP address.

Step 402: The L-LMF discovers a PCF by querying a binding service function (BSF) (not shown in FIG. 4) with the IP address identifying the target UE. The BSF returns the address of the PCF serving PDU session(s) identified by the UE IP address. The L-LMF then sends a Npcf_PolicyAuthorization_Create request message to the PCF. If the L-LMF is not in a trusted domain, the L-LMF communicates with the PCF via a network exposure function (NEF) (not shown in FIG. 4). The Npcf_PolicyAuthorization_Create request message may include at least one of a DNAI (Data Network Access Identifier) identifying the local area/Edge Computing area, a traffic description of the Network Positioning Messages, a Routing ID (e.g. LMF address) identifying the LMF and an LMF Correlation ID identifying this location request procedure in the LMF.

Step 403: The PCF generates LCS rule information in policy and charging control (PCC) rules of the PDU session. The LCS rule information (e.g. PCC rule) includes at least one of the DNAI, the traffic description of the Network Positioning Messages, the Routing ID and the LMF Correlation ID. The PCF sends a Npcf_SMPolicyControl_UpdateNotify Request to the SMF, to update the PCC rules (i.e. the LCS rule information) stored in the SMF.

Step 404: The SMF determines the UPF serving the DNAI and sends an N4 Session Update request to the UPF, to store the LCS rule information (e.g. PCC rule) in the UPF. The LCS rule information in the UPF includes at least one of the traffic description used to indicate the Network Positioning Messages and the routing ID (i.e. LMF address) and LCS Correlation ID which can be used in notification of the Network Positioning Messages towards the L-LMF. The SMF may allocate a new QoS Flow to deliver the Network Positioning Messages between the RAN and the LMF. As an alternative, the SMF reuses an existing QoS Flow to deliver the Network Positioning Messages between the RAN and the LMF. In an embodiment, the SMF may also request the UPF to set a flag, which is used in the GTP-U header for indicating that the GTP-U content is the Network Positioning Messages. Based on the flag in the GTP-U header, the RAN node and the UPF use the LCS rule to handle related packets.

Step 405: The UPF returns an N4 Session Update response to the SMF.

Step 406: The SMF generates and sends SM N2 information to the RAN via an AMF (not shown in FIG. 4). If the new QoS flow is established for the Network Positioning Messages, the SMF indicates an ID of the new QoS flow to the RAN node. The SMF may also send an indication to the RAN node that the QoS flow allocated for the LCS service and the flag used in the GTP-U header to indicate the Network Positioning Messages.

Step 407: The RAN returns an N2 SM message to the SMF via the AMF.

Step 408: The SMF sends a Npcf_SMPolicyControl_UpdateNotify response to the PCF.

Step 409: The PCF sends a Npcf_PolicyAuthorization_Create response to the L-LMF.

Step 410: The L-LMF sends a (downlink) Network Positioning Message to the UPF by invoking the Nupf_Location service, or by using implementation specific mechanism such as IP tunnel mechanism. The LCS rule in the UPF can be used to detect the downlink Network Positioning Message. The L-LMF provides a UE IP address to the UPF, to allow the UPF to identify PDU session(s) related to the LCS rules (i.e. target UE).

Step 411: Based on the LCS rules received from the SMF, the UPF detects the downlink Network Positioning Message(s) and binds the message into the selected QoS flow. The GTP-U header includes the QFI (QOS Flow ID) and/or the flag indicating that related GTP-U message is the Network Positioning Message.

Step 412: Based on the QFI and optionally the flag in the GTP-U header, the RAN node recognizes that the related GTP-U message is the Network Positioning Message. The RAN node obtains any location information for the target UE. The RAN node returns the obtained location information to the L-LMF in (uplink) Network Positioning message(s) included in an uplink GTP-U message. The GTP-U header of the uplink GTP-U message includes the QFI and/or the flag indicating that the GTP-U message is the Network Positioning Message.

Step 413: The UPF sends the Network Positioning Message to the L-LMF by invoking the Nupf_Location service or by other implementation mechanism. The Network Positioning Message includes the routing ID (i.e. LMF address) and the LMF Correlation ID.

Step 414: The L-LMF transmits a location response comprising the location information of the target UE to the AF. For example, the L-LMF calculates/estimates a current location of the UE and returns the location estimation, the age and accuracy of the location estimation and information associated with the positioning method to the AF/LCS client. Note that steps 410 to 413 may be repeated to request further location information of the target UE.

FIG. 5 shows a schematic diagram of a mobile terminated location request procedure according to an embodiment of the present disclosure. The mobile terminated location request procedure shown in FIG. 5 comprises the following steps:

Step 501: The external location services client (i.e. AF) sends a location request to the L-LMF, for location information of a target UE identified by a GPSI or a SUPI.

Step 502: The L-LMF stores the location request in a user data repository (UDR) by invoking a Nudr_DM_Create (Data Set=Application Data; Data Subset=LCS data, Data Key=S-NSSAI and DNN and/or Internal Group Identifier or SUPI). The LCS data comprises at least one of the DNAI identifying the local area/Edge Computing area, the traffic description of the Network Positioning Messages, the Routing ID (i.e. L-LMF address) identifying the L-LMF and LMF Correlation ID identifying the related location request procedure in the L-LMF. The LCS data may also include subscription information for UE IP address notification.

Step 503: The UDR notifies the LCS data to the PCF serving the S-NSSAI and the DNN.

Step 504: The UE establishes a PDU session towards the S-NSSAI and the DNN. If the PDU session has been established before step 504, step 504 may be omitted.

Step 505: If the LMF has sent subscription information for UE IP address notification in step 502, the PCF sends a notification about the UE IP address to the L-LMF. The LMF can use this UE IP address for Network Positioning Message delivery. The PCF generates LCS rule information in PCC rule(s) of the PDU session. The LCS rule information (e.g. PCC rule) includes at least one of the DNAI, the traffic description of the Network Positioning Messages, the Routing ID and the LMF Correlation ID. The PCF sends a Npcf_SMPolicyControl_UpdateNotify Request to the SMF, to update the PCC rules (i.e. the LCS rule information) stored in the SMF.

Step 506: The SMF determines the UPF serving the DNAI and sends an N4 Session Update request to the UPF, to store the LCS rule information (e.g. PCC rule) in the UPF. The LCS rule information in the UPF includes at least one of the traffic description used to indicate the Network Positioning Messages and the routing ID (i.e. LMF address) and LCS Correlation ID which can be used in notification of the Network Positioning Messages towards the L-LMF. The SMF may allocate a new QoS Flow to deliver the Network Positioning Messages between the RAN and the LMF. As an alternative, the SMF reuses an existing QoS Flow to deliver the Network Positioning Messages between the RAN and the LMF. In an embodiment, the SMF may also request the UPF to set a flag, which is used in the GTP-U header for indicating that the GTP-U content is the Network Positioning Messages. Based on the flag in the GTP-U header, the RAN node and the UPF use the LCS rule to handle related packets.

Step 507: The UPF returns an N4 Session Update response to the SMF.

Step 508: The SMF generates and sends SM N2 information to the RAN via an AMF (not shown in FIG. 4). If the new QoS flow is established for the Network Positioning Messages, the SMF indicates an ID of the new QoS flow to the RAN node. The SMF may also send an indication to the RAN node that the QoS flow allocated for the LCS service and the flag used in the GTP-U header to indicate the Network Positioning Messages.

Step 509: The RAN returns an N2 SM message to the SMF via the AMF.

Step 510: The SMF sends a Npcf_SMPolicyControl_UpdateNotify response to the PCF.

Step 511: The PCF sends a Npcf_PolicyAuthorization_Create response to the L-LMF.

Step 512: The L-LMF sends a (downlink) Network Positioning Message to the UPF by invoking the Nupf_Location service, or by using implementation specific mechanism such as IP tunnel mechanism. The LCS rule in the UPF can be used to detect the downlink Network Positioning Message. The L-LMF provides a UE IP address to the UPF which may be received in step 505, to allow the UPF to identify PDU session(s) related to the LCS rules (i.e. target UE).

Step 513: Based on the LCS rules received from the SMF, the UPF detects the downlink Network Positioning Message(s) and binds the message into the selected QoS flow. The GTP-U header includes the QFI (QOS Flow ID) and/or the flag indicating that related GTP-U message is the Network Positioning Message.

Step 514: Based on the QFI and optionally the flag in the GTP-U header, the RAN node recognizes that the related GTP-U message is the Network Positioning Message. The RAN node obtains any location information for the target UE. The RAN node returns the obtained location information to the L-LMF in (uplink) Network Positioning message(s) included in an uplink GTP-U message. The GTP-U header of the uplink GTP-U message includes the QFI and/or the flag indicating that the GTP-U message is the Network Positioning Message.

Step 515: The UPF sends the Network Positioning Message to the L-LMF by invoking the Nupf_Location service or by other implementation mechanism. The Network Positioning Message includes the routing ID (i.e. LMF address) and the LMF Correlation ID.

Step 516: The L-LMF transmits a location response comprising the location information of the target UE to the AF. For example, the L-LMF calculates/estimates a current location of the UE and returns the location estimation, the age and accuracy of the location estimation and information associated with the positioning method to the AF/LCS client. Note that steps 512 to 515 may be repeated to request further location information of the target UE.

FIG. 6 relates to a schematic diagram of a wireless terminal 60 according to an embodiment of the present disclosure. The wireless terminal 60 may be a user equipment (UE), a mobile phone, a laptop, a tablet computer, an electronic book or a portable computer system and is not limited herein. The wireless terminal 60 may include a processor 600 such as a microprocessor or Application Specific Integrated Circuit (ASIC), a storage unit 610 and a communication unit 620. The storage unit 610 may be any data storage device that stores a program code 612, which is accessed and executed by the processor 600. Embodiments of the storage unit 612 include but are not limited to a subscriber identity module (SIM), read-only memory (ROM), flash memory, random-access memory (RAM), hard-disk, and optical data storage device. The communication unit 620 may a transceiver and is used to transmit and receive signals (e.g. messages or packets) according to processing results of the processor 600. In an embodiment, the communication unit 620 transmits and receives the signals via at least one antenna 622 shown in FIG. 6.

In an embodiment, the storage unit 610 and the program code 612 may be omitted and the processor 600 may include a storage unit with stored program code.

The processor 600 may implement any one of the steps in exemplified embodiments on the wireless terminal 60, e.g., by executing the program code 612.

The communication unit 620 may be a transceiver. The communication unit 620 may as an alternative or in addition be combining a transmitting unit and a receiving unit configured to transmit and to receive, respectively, signals to and from a wireless network node (e.g. a base station).

FIG. 7 relates to a schematic diagram of a wireless network node 70 according to an embodiment of the present disclosure. The wireless network node 70 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 70 may comprise (perform functionalities of) at least one network function such as an access and mobility management function (AMF), a session management function (SMF), a user place function (UPF), a policy control function (PCF), an application function (AF), a location management function (LMF), etc. The wireless network node 70 may include a processor 700 such as a microprocessor or ASIC, a storage unit 710 and a communication unit 720. The storage unit 710 may be any data storage device that stores a program code 712, which is accessed and executed by the processor 700. Examples of the storage unit 712 include but are not limited to a SIM, ROM, flash memory, RAM, hard-disk, and optical data storage device. The communication unit 720 may be a transceiver and is used to transmit and receive signals (e.g. messages or packets) according to processing results of the processor 700. In an example, the communication unit 720 transmits and receives the signals via at least one antenna 722 shown in FIG. 7.

In an embodiment, the storage unit 710 and the program code 712 may be omitted. The processor 700 may include a storage unit with stored program code.

The processor 700 may implement any steps described in exemplified embodiments on the wireless network node 70, e.g., via executing the program code 712.

The communication unit 720 may be a transceiver. The communication unit 720 may as an alternative or in addition be combining a transmitting unit and a receiving unit configured to transmit and to receive, respectively, signals to and from a wireless terminal (e.g. a user equipment or another wireless network node).

FIG. 8 shows a flowchart of a method according to an embodiment of the present disclosure. The method shown in FIG. 8 may be used in an LMF (e.g. L-LMF or a wireless device comprising the LMF/L-LMF or a wireless device performing functionalities of the LMF/L-LMF) and comprises the following steps:

Step 801: Transmit, to a PCF, a rule creating message associated with a location service for the LMF.

Step 802: Transmit, to a UPF, a downlink network positioning message associated with the location service of a wireless terminal.

Step 803: Receive, from the UPF, an uplink network positioning message comprising location information of the wireless terminal.

In FIG. 8, the LMF transmits a rule creating message (e.g. Npcf_PolicyAuthorization_Create message) to a PCF for the LCS of the LMF. For example, the LMF may transmit the rule creating message after receiving a request for location information of a wireless terminal (e.g. UE). The request may be received from an AF or LCS client. To acquire the location information of the wireless terminal, the LMF transmits a downlink network positioning message associated with the LCS of the wireless terminal. The LMF therefore can receive an uplink network positioning message comprising the location information of the wireless terminal. The LMF may transmit the location information of the wireless terminal to the AF or LCS client. Because the PCF generates and updates related PCC rule(s) or LCS rule(s) based on the rule creating message, the UPF is able to recognize and handle the downlink/uplink network positioning message(s) of the LCS.

By transmitting the rule creating message, a user plane data transport (e.g. a GTP-U tunnel) is established between the LMF and the UPF or RAN node serving the wireless terminal. The user plane data transport is configured to transmit/receive network positioning message(s) of the LCS. For example, a new (dedicated) QoS flow or an existing QoS flow may be allocated for the network positioning message(s) of the LCS (see, e.g., steps 402 to 406 or 502 to 508). In a case of the new QoS flow is allocated for the LCS, the network positioning message may comprise the QFI of the new QoS flow, e.g., in the GTP-U header. In a case of the existing QoS flow is allocated, the network positioning message may comprise at least one of the QFI of the existing QoS flow and a flag e.g., in the GTP-U header. The flag indicates that the related contents are the network positioning message. Based on the QFI and/or the flag, the UPF and/or the RAN node is able to recognize the network positioning message transmitted to and/or from the LMF and to perform corresponding operations. The location information of the wireless terminal is therefore not exposed to the core network (functions).

In an embodiment, the rule creating message comprises at least one of a DNAI associated with the LMF, a traffic description associated with a network positioning message (e.g. downlink and/or uplink network positioning message) of the LCS, a routing ID associated with the LMF or an LCS correlation ID associated with the LMF. The DNAI may be used to identify a local area of edge computing area associated with the LMF. The routing ID may be an address of the LMF (i.e. LMF address) and the LCS correlation ID may be used to identify the LCS associated with the wireless terminal at the LMF.

In an embodiment, the downlink network positioning message comprises an IP address associated with the wireless terminal.

In an embodiment, the uplink network positioning message comprises at least one of a routing ID associated with the location management function or an LCS correlation ID associated with the LMF.

FIG. 9 shows a flowchart of a method according to an embodiment of the present disclosure. The method shown in FIG. 9 may be used in a PCF (e.g. a wireless device comprising the PCF or a wireless device performing functionalities of the PCF) and comprises the following steps:

Step 901: Receive a rule creating message associated with an LCS for an LMF.

Step 902: Transmit, to an SMF, a PCC rule of a PDU session associated with the LCS.

More specifically, the PCF receives a rule creating message associated an LCS for an LMF (e.g. L-LMF). According to the rule creating message, the PCF transmits a PCC rule of a PDU session associated with the LCS to an SMF. For example, the PCF may determine the PDU session based on the rule creating message (e.g. a DNAI comprised in the rule creating message). As an alternative or in addition, the PCF may generate the PCC rule based on the rule creating message.

In an embodiment, the PCF receives the rule creating message from the LMF (e.g. L-LMF) or a UDR.

In an embodiment, the rule creating message comprises at least one of a DNAI associated with the LMF, a traffic description associated with a network positioning message (i.e. downlink/uplink network positioning message) of the LCS, a routing ID associated with the LMF or an LCS ID associated with the LMF.

In an embodiment, the PCC rule comprises at least one of a DNAI associated with the LMF, a traffic description associated with a network positioning message of the LCS, a routing ID associated with the LMF or an LCS ID associated with the LMF. For example, the information comprised in the PCC rule may be those comprised in the rule creating message.

FIG. 10 shows a flowchart of a method according to an embodiment of the present disclosure. The method shown in FIG. 10 may be used in an SMF (e.g. wireless device comprising the SMF or a wireless device performing functionalities of the SMF) and comprises the following steps:

Step 1001: Receive, from a PCF, a PCC rule associated with a PDU session allocated for an LCS of an LMF.

Step 1002: Transmit, to a UPF, information of a QoS flow allocated for the LCS.

In FIG. 10, the SMF receives a PCC rule associated with a PDU session allocated for an LCS of an LMF. Based on the PCC rule, the SMF transmits information of a QoS flow allocated for the LCS. The allocated QoS flow may be a new QoS flow established for the LCS or an existing QoS flow in the PDU session.

In an embodiment, the PCC rule comprises at least one of a DNAI associated with the LMF, a traffic description associated with a network positioning message of the LCS, a routing ID associated with the LMF or an LCS ID associated with the LMF.

In an embodiment, the information of the QoS flow comprises at least one of a traffic description associated with a network positioning message (i.e. downlink/uplink network positioning message) of the LCS, a routing ID associated with the LMF or a LCS correlation ID associated with the LMF.

In an embodiment, the SMF determines the UPF based on a DNAI comprised in the PCC rule.

In an embodiment, the SMF transmits an indication of setting a flag configured to identify/indicate (downlink/uplink) network positioning message(s) of the LCS to the UPF or to a wireless network node (e.g. RAN node serving the wireless terminal).

In an embodiment, the SMF transmits the flag configured to identify/indicate (downlink/uplink) network positioning message(s) of the LCS to the wireless network node serving the wireless terminal. For example, the SMF transmits the indication to the UPF, receives the flag from the UPF and transmits the flag to the wireless network node. Note that the flag is used in the GTP-U header, e.g., for indicating that related GTP-U packet/message is the (downlink/uplink) network positioning message of the LCS.

FIG. 11 shows a flowchart of a method according to an embodiment of the present disclosure. The method shown in FIG. 11 may be used in a UPF (e.g. wireless device comprising the UPF or a wireless device performing functionalities of the UPF) and comprises the following steps:

Step 1101: Receive, from an SMF, information of a QoS allocated for an LCS of an LMF.

Step 1102: Receive, from the LMF, a downlink network positioning message associated with the LCS of a wireless terminal based on the information.

Step 1103: Transmit, to a wireless network node, the downlink network positioning message.

Step 1104: Receive, from the wireless network node, an uplink network positioning message comprising location information of the wireless terminal.

Step 1105: Transmit, to the LMF, the uplink network positioning message.

Specifically, the UPF receives information of a QoS flow allocated for an LCS of an LMF (e.g. L-LMF). Based on the received information, the UPF is able to recognize and handle (downlink/uplink) network positioning message(s) of the LCS. In FIG. 11, the UPF receives a downlink network positioning message from the LMF, wherein the downlink network positioning message is associated with the LCS of a wireless terminal. The UPF transmits the downlink network positioning message to a wireless network node (e.g. RAN node) serving the wireless terminal. Next, the UPF receives an uplink network positioning message comprising location information of the wireless terminal based on the information and transmits the received uplink network positioning message to the LMF.

In an embodiment, the information of the QoS allocated for LCS comprises at least one of a traffic description associated with a network positioning message (e.g. downlink and/or uplink network positioning message) of the LCS, a routing ID associated with the LMF or an LCS identifier associated with the LMF.

In an embodiment, the downlink network positioning message is transmitted and the uplink network positioning message is received in a GTP-U (packet or message).

In an embodiment, the header of the GTP-U (packet or message) (i.e. GTP-U header) comprises an ID of the QoS flow (i.e. QFI) and/or a flag identifying/indicating the network positioning message of the LCS.

In an embodiment, the UPF may receive an indication of setting the flag from the SMF. Based on the indication, the UPF sets the flag itself. The UPF may returns the flag to the SMF.

FIG. 12 shows a flowchart of a method according to an embodiment of the present disclosure. The method shown in FIG. 12 may be used in a wireless network node (e.g. RAN node) and comprises the following steps:

Step 1201: Receive, from an SMF, information of a QoS flow allocated for an LCS of an LMF.

Step 1202: Receive, from a UPF, a downlink network positioning message associated with the LCS of a wireless terminal based on the information.

Step 1203: Transmit, to the UPF, an uplink network positioning message comprising location information of the wireless terminal.

In FIG. 12, the wireless network node receives information of a QoS flow allocated for an LCS of an LMF from an SMF. Based on the information, the wireless network node receives a downlink network positioning message associated with the LCS of a wireless terminal (e.g. UE). According to the downlink network positioning message, the wireless network node collects/obtains location information of the wireless terminal. The collected location information is transmitted to the UPF in an uplink network positioning message.

In an embodiment, the downlink network positioning message is transmitted and the uplink network positioning message is received in a GTP-U (message/packet).

In an embodiment, a header of the GTP-U (message/packet) (i.e. the GTP-U header) comprises at least one of an ID of the QoS flow (i.e. QFI) and a flag used to identify/indicate the network positioning message of the LCS.

In an embodiment, the wireless network node may receive the flag from the SMF (e.g. in the information of the QoS flow).

In an embodiment, the wireless network may receive an indication of setting the flag from the SMF. Based on the indication, the wireless network node sets the flag itself.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method for use in a location management function, the method comprising:
transmitting, to a policy control function, a rule creating message associated with a location service for the location management function,
transmitting, to a user plane function, a downlink network positioning message associated with the location service of a wireless terminal, and
receiving, from the user plane function, an uplink network positioning message comprising location information of the wireless terminal.

2. The wireless communication method of claim 1, wherein the rule creating message comprises at least one of a data network access identifier associated with the location management function, a traffic description associated with a network positioning message of the location service, a routing identifier associated with the location management function or a location service correlation identifier associated with the location management function.

3. The wireless communication method of claim 1, wherein the downlink network positioning message comprises an internet protocol address associated with the wireless terminal.

4. The wireless communication method of claim 1, wherein the uplink network positioning message further comprises at least one of a routing identifier associated with the location management function or a location service correlation identifier associated with the location management function.

5-9. (canceled)

10. A wireless communication method for use in a session management function, the method comprising:
receiving, from a policy control function, a policy control and charging rule associated with a protocol data unit session allocated for a location service of a location management function, and
transmitting, to a user plane function, information of a quality of service flow allocated for the location service.

11. The wireless communication method of claim 10, wherein the policy control and charging rule comprises at least one of a data network access identifier associated with the location management function, a traffic description associated with a network positioning message of the location service, a routing identifier associated with the location management function or a location service correlation identifier associated with the location management function.

12. The wireless communication method of claim 10, wherein the information of the quality of service flow comprises at least one of a traffic description associated with a network positioning message of the location service, a routing identifier associated with the location management function or a location service correlation identifier associated with the location management function.

13. The wireless communication method of claim 10, further comprising:
determining the user plane function according to a data network access identifier comprised in the policy control and charging rule.

14. The wireless communication method of claim 10, further comprising at least one of:
transmitting, to at least one of the user plane function or a wireless network node, an indication of setting a flag configured to indicate a network positioning message of the location service, or
transmitting, to the wireless network node, the flag configured to identify the network positioning message of the location service.

15. The wireless communication method of claim 14, wherein the flag is used in a general packet radio service tunneling protocol user plane header.

16. A wireless communication method for use in a user plane function, the method comprising:
receiving, from a session management function, information of a quality of service flow allocated for a location service of a location management function,
receiving, from the location management function, a downlink network positioning message associated with the location service of a wireless terminal based on the information,
transmitting, to a wireless network node, the downlink network positioning message,
receiving, from the wireless network node, an uplink network positioning message comprising location information of the wireless terminal based on the information, and
transmitting, to the location management function, the uplink network positioning message.

17. The wireless communication method of claim 16, wherein the information of the quality of service flow allocated for the location service comprises at least one of a traffic description associated with a network positioning message of the location service, a routing identifier associated with the location management function or a location service correlation identifier associated with the location management function.

18. The wireless communication method of claim 16, wherein the downlink network positioning message is transmitted and the uplink network positioning message is received in a general packet radio service tunneling protocol user plane message.

19. The wireless communication of claim 18, wherein a header of the general packet radio service tunneling protocol user plane comprises at least one of an identifier of the quality of service flow allocated for the location service or a flag configured to identify the network positioning message of the location service.

20. The wireless communication method of claim 19, further comprising:
receiving, from a session management function, an indication of setting the flag.

21. The wireless communication method of claim 16, wherein the uplink network positioning message further comprises at least one of a routing identifier associated with the location management function or a location service correlation identifier associated with the location management function.

22-27. (canceled)

28. A wireless device comprising a location management function, the wireless device comprising: a communication unit, configured to implement the wireless communication method of claim 1.

29-31. (canceled)

32. A wireless device comprising a session management function, the wireless device comprising: a communication unit, configured to implement the wireless communication method of claim 10.

33. (canceled)

34. A wireless device comprising a user plane function, the wireless device comprising: a communication unit, configured to implement the wireless communication method of claim 16.

35-38. (canceled)

39. A non-transitory computer-readable storage medium storing a computer program, wherein when executed by a processor, the computer program causes the processor to perform the wireless communication method of claim 1.
